(19) United States
(12) Patent Application Publication
(10) Pub. No.: US 2015/0220295 A1
(43) Pub. Date: Aug. 6, 2015

(54) USER TERMINAL APPARATUS, DISPLAY APPARATUS, AND CONTROL METHODS THEREOF

(71) Applicant: SAMSUNG ELECTRONICS CO., LTD., Suwon-si (KR)

(72) Inventors: Sung-yeol KIM, Suwon-si (KR); Sung-jin KIM, Suwon-si (KR); Ho-young LEE, Suwon-si (KR)

(73) Assignee: SAMSUNG ELECTRONICS CO., LTD., Suwon-si (KR)

(21) Appl. No.: 14/338,818

(22) Filed: Jul. 23, 2014

(30) Foreign Application Priority Data
Feb. 6, 2014 (KR) 10-2014-0013751

(51) Int. Cl. G06F 3/14; G06F 3/01; G09G 5/14; G09G 5/36

(52) U.S. Cl. CPC G06F 3/1415; G09G 5/363; G06F 3/013; G09G 5/14; G06F 3/1454; G09G 2320/0261; G09G 2340/02; G09G 2340/0407; G09G 2354/00; G09G 2360/10; G09G 2370/025

(57) ABSTRACT

A display apparatus is provided, including a communicator configured to communicate with an external user terminal apparatus, a gaze tracker configured to track a user's gaze, and a controller configured to determine a position of the user's gaze based on first gaze tracking information acquired by the gaze tracker and second gaze tracking information received from the user terminal apparatus. The controller is further configured to request information regarding an event that has occurred in the user terminal apparatus from the user terminal apparatus based on the determination result.

### CROSS-REFERENCE TO RELATED APPLICATION

This application claims benefit from Korean Patent Application No. 10-2014-0013751, filed on Feb. 6, 2014, in the Korean Intellectual Property Office, the disclosure of which is incorporated herein by reference in its entirety.

### BACKGROUND OF THE INVENTION

1. Field of the Invention

Apparatuses and methods consistent with exemplary embodiments relate to a user terminal apparatus, a display apparatus, and control methods thereof, and more particularly, to a user terminal apparatus, a display apparatus, and control methods thereof capable of providing a content mirroring function.

2. Description of the Related Art

Thanks to the development of electronic technologies, diverse types of electronic devices have developed and propagated. In particular, the technologies of display apparatuses such as televisions (TVs) which are one of the most commonly used electronic appliances in homes, has developed rapidly in recent years.

Recently, a content mirroring function has been developed by which the same content displayed on a screen of a user terminal apparatus, such as a smart phone, is transmitted, e.g. in a unicast form, and displayed on a display apparatus such as a TV.

However, private content may inadvertently be mirrored in a shared device, thereby incurring inconvenience, or a plurality of devices may reproduce content, thereby disturbing a users' content viewing.

### SUMMARY

One or more exemplary embodiments may overcome the above disadvantages and other disadvantages not described above. Also, exemplary embodiments described herein are not required to overcome the disadvantages described above.

One or more exemplary embodiments provide a user terminal apparatus, a display apparatus, and control methods thereof capable of controlling a content mirroring function according to a user's gaze.

According to an aspect of an exemplary embodiment, a user terminal apparatus includes a communicator configured to communicate with an external display apparatus, a gaze tracker configured to track a user's gaze, and a controller configured to transmit information regarding the user's gaze acquired by the gaze tracker to the external display apparatus, and when a request for information regarding an event that occurs in the user terminal apparatus is received from the external display apparatus, to transmit the requested information to the external display apparatus.

When a request for content that the user terminal apparatus is displaying is received from the external display apparatus, the controller may transmit the requested content to the external display apparatus.

When a request for information that the user terminal apparatus has received is received from the external display apparatus, the controller may transmit the received information to the external display apparatus.

When a control request for an output state of the user terminal apparatus is received from the external display apparatus, the controller may control the output state of the user terminal apparatus based on the received control request.

The output state of the user terminal apparatus may include at least one of a screen output state and an audio output state of the user terminal apparatus.

According to an aspect of another exemplary embodiment, a display apparatus includes a communicator configured to communicate with an external user terminal apparatus, a gaze tracker configured to track a user's gaze, and a controller configured to determine a position of the user's gaze based on first gaze tracking information acquired by the gaze tracker and second gaze tracking information received from the user terminal apparatus, and to request information regarding an event that occurs in the user terminal apparatus from the user terminal apparatus based on determination result.

The display apparatus may further include a display, wherein the controller may control the display to display content received from the user terminal apparatus in response to the request transmitted to the user terminal apparatus.

The controller may control an output state of the display apparatus based on the determination result.

The output state of the display apparatus may include at least one of a screen output state and an audio output state of the display apparatus.

According to an aspect of another exemplary embodiment, a display system includes a user terminal apparatus and a display apparatus, wherein the user terminal apparatus is configured to transmit information regarding a tracked user's gaze to a display apparatus, and when a request for information regarding an event that occurs in the user terminal apparatus is received from the display apparatus, the user terminal apparatus is configured to transmit the requested information to the display apparatus. The display apparatus is configured to determine a position of the user's gaze based on gaze tracking information received from the user terminal apparatus and gaze tracking information acquired by the display apparatus, and is configured to request information regarding an event that occurs in the user terminal apparatus from the user terminal apparatus based on determination result.

According to an aspect of another exemplary embodiment, a control method of a user terminal apparatus includes tracking a user's gaze, transmitting information regarding the tracked user's gaze to an external display apparatus, and when a request for information regarding an event that occurs in the user terminal apparatus is received from the display apparatus, transmitting the requested information to the external display apparatus.

When a request for content displayed on the user terminal apparatus is received from the external display apparatus, the requested content may be transmitted to the external display apparatus.

When a request for information that the user terminal apparatus receives is received from the external display apparatus, the requested information may be transmitted to the external display apparatus.

The method may further include, when a control request for an output state of the user terminal apparatus is received from the external display apparatus, controlling the output state of the user terminal apparatus based on the received control request.

The output state of the user terminal apparatus may include at least one of a screen output state and an audio output state of the user terminal apparatus.

According to an aspect of another exemplary embodiment, a control method of a display apparatus includes acquiring first gaze tracking information by tracking a user's gaze, determining a position of the user's gaze based on the first gaze tracking information and second gaze tracking information received from a user terminal apparatus, and requesting information regarding an event that has occurred in the user terminal apparatus from the user terminal apparatus based on determination result.

The method may further include displaying content received from the user terminal apparatus in response to the request transmitted to the user terminal apparatus.

The method may further include controlling an output state of the display apparatus based on the determination result.

The output state of the display apparatus may include at least one of a screen output state and an audio output state of the display apparatus.

According to an aspect of another exemplary embodiment, a control method of a display system including a user terminal apparatus and a display apparatus includes by the user terminal apparatus, transmitting information regarding a tracked user's gaze to the display apparatus, and when a request for information regarding an event that has occurred in the user terminal apparatus is received from the display apparatus, transmitting the requested information to the display apparatus, and by the display apparatus, determining a position of the user's gaze based on gaze tracking information received from the user terminal apparatus and gaze tracking information acquired by the display apparatus, and requesting information regarding an event that has occurred in the user terminal apparatus from the user terminal apparatus based on determination result.

According to one or more exemplary embodiments, a content mirroring function that coincides with the user's intention may be provided. In addition, when content is viewed using the content mirroring function, optimal viewing environment may be provided.

Additional and/or other aspects and advantages will be set forth in part in the description which follows and, in part, will be obvious from the description, or may be learned by practice.

### BRIEF DESCRIPTION OF THE DRAWING FIGURES

The above and/or other exemplary aspects and advantages will be more apparent by describing certain exemplary embodiments with reference to the accompanying drawings, in which:

FIG. 1 illustrates an example of a content transmission system according to an exemplary embodiment;

FIG. 2 illustrates operation of the content transmission system shown in FIG. 1;

FIG. 3 is a block diagram of a configuration of a user terminal apparatus according to an exemplary embodiment;

FIG. 4 is a block diagram of a configuration of a display apparatus according to an exemplary embodiment;

FIG. 5 illustrates a method for acquiring gaze information according to an exemplary embodiment;

FIGS. 6A to 6C illustrate a content mirroring method according to an exemplary embodiment;

FIGS. 7A to 7C illustrate a content mirroring method according to another exemplary embodiment;

FIGS. 8A to 8C illustrate an output state control method according to an exemplary embodiment;

FIGS. 9A to 9C illustrate an output state control method according to another exemplary embodiment;

FIG. 10 is a flow chart of a control method of the user terminal apparatus according to an exemplary embodiment; and

FIG. 11 is a flow chart of a control method of the display apparatus according to an exemplary embodiment.

### DETAILED DESCRIPTION OF THE EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that exemplary embodiments can be carried out without those specifically defined matters. Also, well-known functions or constructions are not described in detail since they would obscure the description with unnecessary detail.

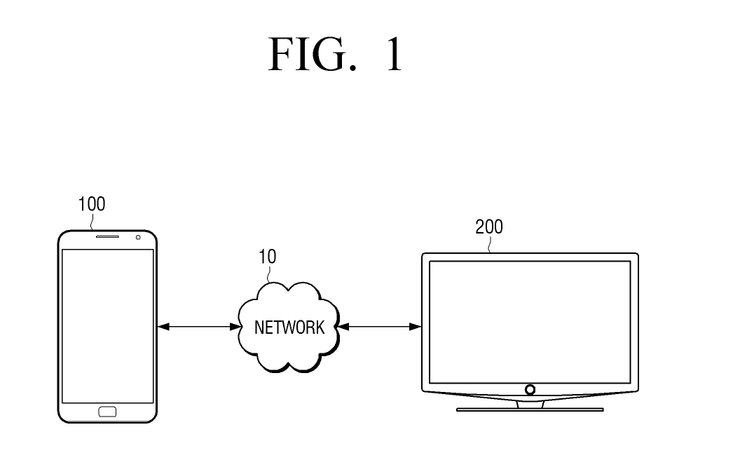

FIG. 1 illustrates an example of a content transmission system according to an exemplary embodiment. With reference to FIG. 1, the content transmission system may include a user terminal apparatus 100 and a display apparatus 200.

The user terminal apparatus 100 may transmit content to the display apparatus 200 over a network 10. Accordingly, the user terminal apparatus 100 may act as a source device, and the display apparatus 200 may act as a target device or a client device. For example, the user terminal apparatus 100 may be implemented with a wireless terminal such as a mobile phone like a smart phone, a tablet computer, a personal digital assistant (PDA), and the like, and may transmit stored content to the display apparatus 200 in a streaming form.

In particular, the user terminal apparatus 100 may track a user's gaze, transmit information regarding the tracked gaze to the display apparatus 200, and receive a content transmission request from the display apparatus 200 based on the gaze tracking information transmitted to the display apparatus 200.

The display apparatus 200 may be connected to the user terminal apparatus 100 over the network 10, may receive content from the user terminal apparatus 100, and may reproduce the received content. In particular, the display apparatus 200 may receive content in a streaming form and reproduce the content in real time. For example, the display apparatus 200 may be an electronic device that may be shared with other users, such as a digital TV, a personal computer (PC), a notebook computer, and the like, but is not limited thereto.

The user terminal apparatus 100 and the external device 200 may be connected to each other by any of a number of communication methods such as Bluetooth, wireless fidelity (Wi-Fi), a personal area network (PAN), a local area network (LAN), a wide area network (WAN), a wired I/O, a universal serial bus (USB), and the like. For example, when a user command to transmit content is input to the user terminal apparatus 100, the user terminal apparatus 100 searches for adjacent devices using digital living network appliance (DLNA) technology. When a device to be linked with the user terminal apparatus 100 is selected from among the found devices, the user terminal apparatus 100 performs pairing and wireless communication with the linked device. The user terminal apparatus 100 may perform pairing using other communication methods such as BT and Wi-Fi, but a detailed description thereof is omitted.

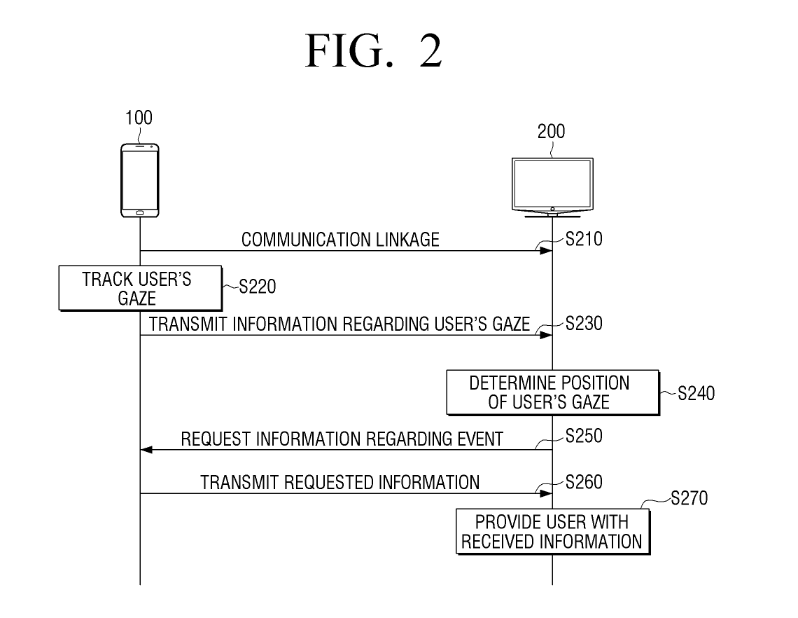

FIG. 2 illustrates operation of the content transmission system shown in FIG. 1.

With reference to FIG. 2, the user terminal apparatus 100 performs communication linkage with the external display apparatus 200 in accordance with a user command (S210). More specifically, the user terminal apparatus 100 may search for an adjacent external device capable of wireless communication, and perform wireless communication linkage with the found external device through a pairing process. The user command may be a content transmission command, but is not limited thereto. Based on a separate user command, the user terminal apparatus 100 may also perform communication linkage with the display apparatus 200.

The user terminal apparatus 100 tracks the user's gaze (S220), and transmits information regarding the tracked user's gaze to the display apparatus 200 (S230). The information regarding the tracked user's gaze that is transmitted to the display apparatus 200 may be information regarding the size, pose, color, position, and the like of the user's eyes and/or face.

The display apparatus 200 determines a position of the user's gaze based on the information regarding the user's gaze which is received from the user terminal apparatus 100 (S240). Additional information regarding the user's gaze may be tracked by the display apparatus 200. More specifically, the display apparatus 200 may determine a device that the user gazes at.

When it is determined that the user gazes at the display apparatus 200, the display apparatus 200 requests, from the user terminal apparatus 100, information regarding an event that is occurring in the user terminal apparatus 100 (S250).

The user terminal apparatus 100 transmits the information regarding the event to the display apparatus 200 (S260). The information regarding the event may be displayed content, received information (for example, a message, a mail, etc), and the like.

Subsequently, the display apparatus 200 provides the user with the received information (S270). For example, the display apparatus 200 may display content streamed by the user terminal apparatus 100.

The user terminal apparatus 100 may convert content to be transmitted into a format that matches a display format of the display apparatus 200 and may transmit the converted content to the display apparatus 200, or the display apparatus 200 may convert content received from the user terminal apparatus 100 into a format that matches a format of the display apparatus 200. For example, when the user terminal apparatus 100 converts a format of content to be transmitted, the user terminal apparatus 100 may receive information regarding a display format of the display apparatus 200 and convert the format of the content based on the information. For another example, the user terminal apparatus 100 may pre-store initial display information regarding each external device. In other words, the user terminal apparatus 100 may display or store a list of external devices and acquire display information that matches an external device selected from the list.

In the above exemplary embodiment, the user terminal apparatus 100 transmits the display apparatus 200 information regarding the user's gaze tracked by taking a photograph, but this is merely an exemplary embodiment. According to the circumstances, the user terminal apparatus 100 may transmit a photographed image to the display apparatus 200 so that the display apparatus 200 may analyze the received image and acquire information regarding the user's gaze.

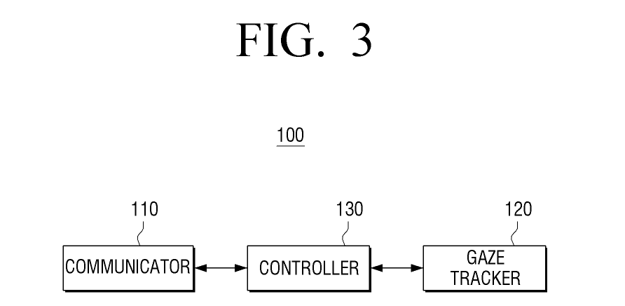

FIG. 3 is a block diagram of a configuration of the user terminal apparatus 100 according to an exemplary embodiment.

With reference to FIG. 3, the user terminal apparatus 100 may include a communicator 110, a gaze tracker 120, and a controller 130.

The communicator 110 communicates with the external display apparatus 200 shown in FIG. 1. That is, the communicator 110 may communicate with diverse kinds of external devices using diverse kinds of communication methods.

To do so, the communicator 110 may include any of diverse types of communication modules such as a short distance wireless communication module (not shown) and a wireless communication module (not shown). A short distance wireless communication module is a module that communicates with the display apparatus 200 at a short distance using a local wireless communication method such as Bluetooth, Zigbee, etc. In addition, the wireless communication module may be a module that is connected to an external network using a wireless communication protocol such as Wi-Fi, institute of electrical and electronics engineers (IEEE), etc. and communicates with the display apparatus 200. The wireless communication module may further include a mobile communication module that accesses a mobile communication network using any of diverse mobile communication standards such as 3^{rd} generation (3G), 3^{rd} generation partnership project (3GPP), long term evolution (LTE), etc. and communicates with the external device 200.

In addition, the communicator 110 may transmit information to or receive information from the display apparatus 200 by communicating with the display apparatus 200.

More specifically, the communicator 110 may transmit, to the display apparatus 200, information regarding the user's gaze tracked by the gaze tracker 120, or may receive information regarding the user's gaze tracked by the display apparatus 200 from the display apparatus 200.

In addition, the communicator 110 may receive information regarding reproduction processing ability of the display apparatus 200. The information regarding reproduction processing ability may include at least one of resolution of content that can be processed by the display apparatus 200, and performance and codec type of a decoder installed in the display apparatus 200.

In addition, the communicator 110 may transmit, to the display apparatus 200, content to be mirrored.

The information regarding the tracked user's gaze and the content to be mirrored may be transmitted using the same communication method or be transmitted according to different methods.

The gaze tracker 120 tracks a position of the user's gaze. To do so, the gaze tracker 120 may include a photographing unit (not shown), or may be connected to a photographing unit (not shown) and receive an image captured by the photographing unit. For convenient description, it is assumed that the gaze tracker 120 is connected to a photographing unit (not shown) and receives an image captured by the photographing unit.

The photographing unit takes a photograph of the user. The photographing unit may include a lens module including a lens, and an image sensor. An image input through the lens is input as an optical signal to the image sensor that acts as film. The image sensor converts the input optical signal into an electrical signal, and transmits the electrical signal to the gaze tracker 120. For example, the photographing unit may be implemented with a stereo camera, an infrared camera, a depth camera, or the like.

The photographing unit may be provided on an outer area of the user terminal apparatus 100. For example, the photographing unit may be provided on a central bezel area of the upper edge, the left edge, or the right edge of the user terminal apparatus 100, but is not limited thereto.

The gaze tracker 120 may detect a face region of the user from the user's photographed image received from the photographing unit, and detect a position of the user's gaze based on the detected face region.

In order to detect the face region, any of existing diverse methods may be used. More specifically, a direct recognition method or a method using statistics may be used. In the direct recognition method, rules are made using physical characteristics such as skin color of the contour of a face image shown on a screen, size of the composition of the face, and comparison, examination, and measurements may be made in accordance with the rules. In the method using statistics, a face region is detected in accordance with a previously learned algorithm.

In other words, the method using statistics is a method in which unique characteristics of an input face are digitized, are compared with a large amount of prepared data (face and shapes of other objects), and are analyzed. In particular, a face region may be detected in accordance with a previously learned algorithm, and multilayer perceptron (MLP), support vector machine (SVM), or the like may be used. Detailed description thereof is omitted here.

More specifically, the gaze tracker 120 analyzes a face region of the user, and acquires information regarding the user's gaze such as the size, pose, angle, color, position, and brightness of the user's eyes and/or face.

The aforementioned methods are merely exemplary. The position of the user's gaze may be detected using any of a number of methods.

The controller 130 controls overall operation of the user terminal apparatus 100. More specifically, the controller 130 controls the communicator 110 to search for adjacent external devices capable of wireless communication and to communicate with an external device selected by the user.

In particular, the controller 130 may transmit information regarding the user's gaze acquired by the gaze tracker 120 to the external display apparatus 200, and may transmit requested information to the external display apparatus 200 when the external display apparatus 200 requests information regarding an event that has occurred in the user terminal apparatus 100.

More specifically, when the external display apparatus 200 requests content that is displayed or stored in the user terminal apparatus 100, the controller 130 may transmit the requested content to the external display apparatus 200. For example, when the user terminal apparatus 100 receives a text message and the display apparatus 200 requests the received information, the controller 130 may transmit the text message to the display apparatus 200.

In addition, when the controller 130 receives a control request for an output state of the user terminal apparatus 100 from the external display apparatus 200, the controller 130 may control the output state of the user terminal apparatus 100 based on the received control request. The output state of the user terminal apparatus 100 may be at least one of a screen output state and an audio output state of the user terminal apparatus 100.

A storage (not shown) is a storage medium which stores diverse kinds of programs necessary to operate the user terminal apparatus 100. The storage may be implemented with a memory, a hard disk drive (HDD), or the like. For example, the storage may include a read-only memory (ROM) to store a program to operate the controller 130, and a random-access memory (RAM) to temporarily store data according to operation of the controller 130. In addition, the storage may further include an electrically erasable and programmable ROM (EEROM) to store diverse kinds of reference data.

In particular, the storage may store diverse data to generate information regarding the user's gaze to transmit to the display apparatus 200 from an image captured by the photographing unit (not shown). For example, the storage may store an algorithm to acquire information regarding the user's gaze, such as the size, pose, color, position, and the like of a user's eyes and/or face, from a captured image.

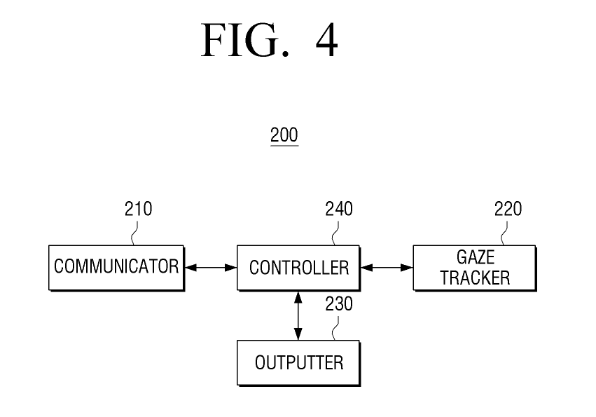

FIG. 4 is a block diagram of a configuration of the display apparatus 200 according to an exemplary embodiment.

With reference to FIG. 4, the display apparatus 200 may include a communicator 210, a gaze tracker 220, an outputter 230, and a controller 240.

The communicator 210 communicates with the external user terminal apparatus 100 shown in FIG. 1. That is, the communicator 210 may communicate with any of diverse kinds of external devices using any of diverse kinds of communication methods. Since the composition of the communicator 210 is the same as that of the communicator 110 in the user terminal apparatus 100 shown in FIG. 3, detailed description is not repeated.

In addition, the communicator 210 may transmit diverse information to and receive diverse information from the user terminal apparatus 100.

More specifically, the communicator 210 may receive information regarding the user's gaze acquired by the user terminal apparatus 100 from the user terminal apparatus 100, and may transmit information regarding the user's gaze tracked by the gaze tracker 220 to the user terminal apparatus 100.

In addition, the communicator 210 may transmit information regarding a reproduction processing ability of the display apparatus 200 to the user terminal apparatus 100.

The gaze tracker 220 tracks a position of the user's gaze. To do so, the gaze tracker 220 may include a photographing unit (not shown), or may be connected to a photographing unit (not shown) and may receive an image captured by the photographing unit. Since the composition of the gaze tracker 220 is the same as that of the gaze tracker 120 in the user terminal apparatus 100 shown in FIG. 3, a detailed description is not repeated.

A display (not shown) displays a screen. The screen may include an application execution screen including diverse contents such as images, videos, text, and music, and a graphical user interface (GUI) screen, and the like.

The display may be implemented with a liquid crystal display (LCD) panel, organic light emitting diodes (OLEDs), or the like, but is not limited thereto. In particular, the display may be provided as a touch screen which is layered with a touch pad.

An audio outputter (not shown) processes and outputs audio data.

The audio outputter performs diverse processing for audio data such as decoding, amplification, and noise filtering, and outputs the processed audio.

The controller 240 controls overall operation of the display apparatus 200.

In particular, the controller 240 may determine a position of the user's gaze based on first gaze tracking information received from the user terminal apparatus 100, and second gaze tracking information tracked by the gaze tracker 220.

In addition, the controller 240 may request information regarding an event that has occurred in the user terminal apparatus 100 from the user terminal apparatus 100 based on determination result regarding the position of the user's gaze. For example, when it is determined that the user gazes at the display apparatus 200, the controller 240 may request, from the user terminal apparatus 100, information regarding an event that has occurred in the user terminal apparatus 100.

In addition, the controller 240 may control the outputter 230 to output content received from the user terminal apparatus 100 in response to a request transmitted to the user terminal apparatus 100. For example, the controller 240 may receive and display text message reception notification information or displayed content.

In addition, the controller 240 may control an output state of the display apparatus 200 based on a determination result regarding the user's gaze. The output state of the display apparatus 200 may include at least one of a screen output state and an audio output state. For example, when it is determined that the user gazes at the user terminal apparatus 100 for a predetermined period of time, the controller 240 may mute the audio output state of the display apparatus 200.

In addition, the controller 240 may run or finish the content mirroring function based on a determination result regarding the user's gaze, or may display a message notifying the user of a changed state of the display apparatus 200 when the output state of the display apparatus 200 changes.

For example, when the content mirroring function is run, the controller 240 displays a message notifying the user that the content mirroring function is run. When the audio output state becomes muted, the controller 240 displays a message notifying the user of the muted state.

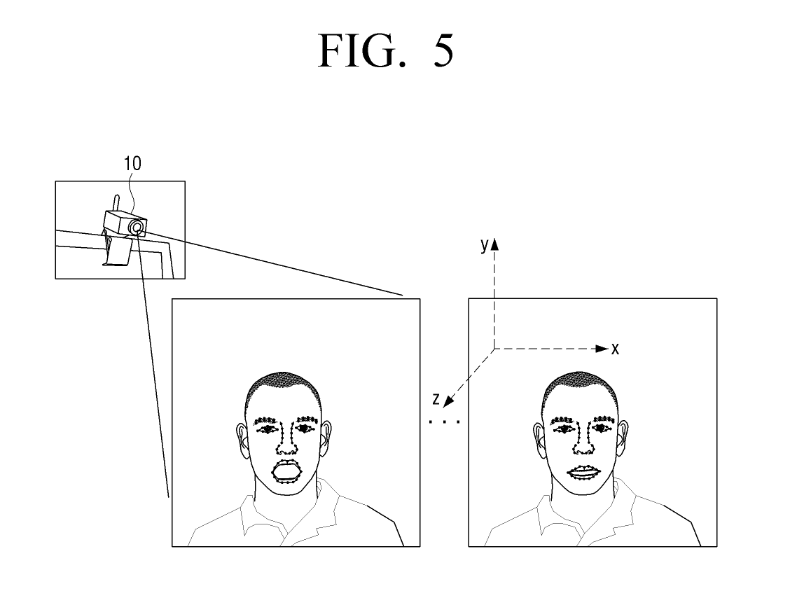

FIG. 5 illustrates a method for acquiring gaze information according to an exemplary embodiment.

The user's gaze may be detected by analyzing a photographed image of a face region of the user. More specifically, a pupil region of the user is detected by analyzing the photographed image using an image processing method, and then the user's gaze is detected by tracking change in the position of the pupil region. However, a method for detecting the user's gaze is not limited thereto. In order to track the user's gaze, various information such as the size, pose, color, position, and the light of the user's eyes and/or face may be used.

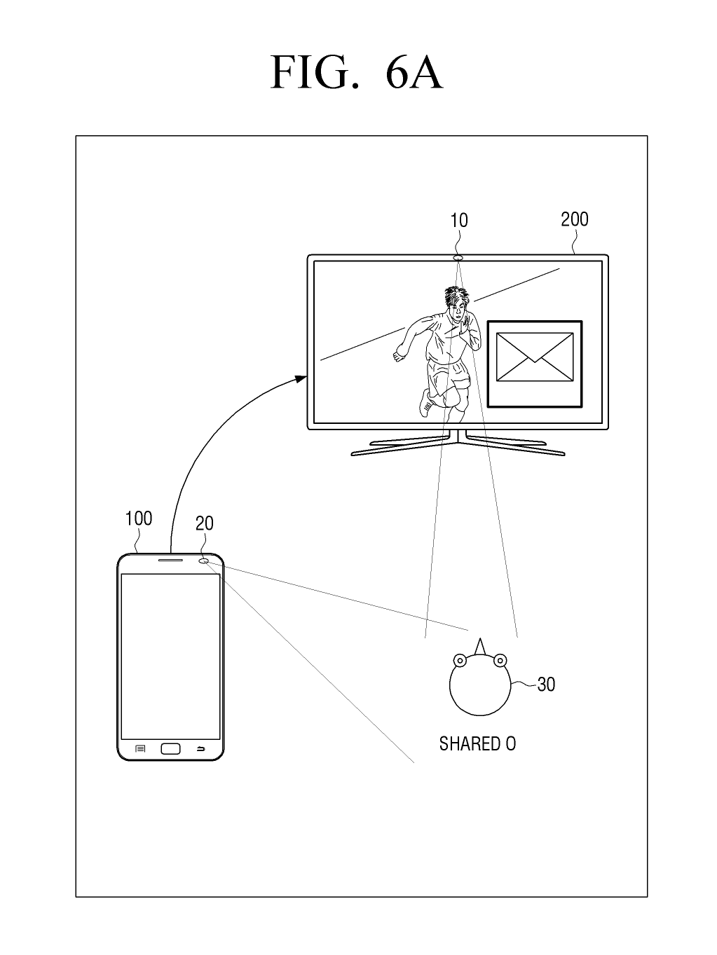

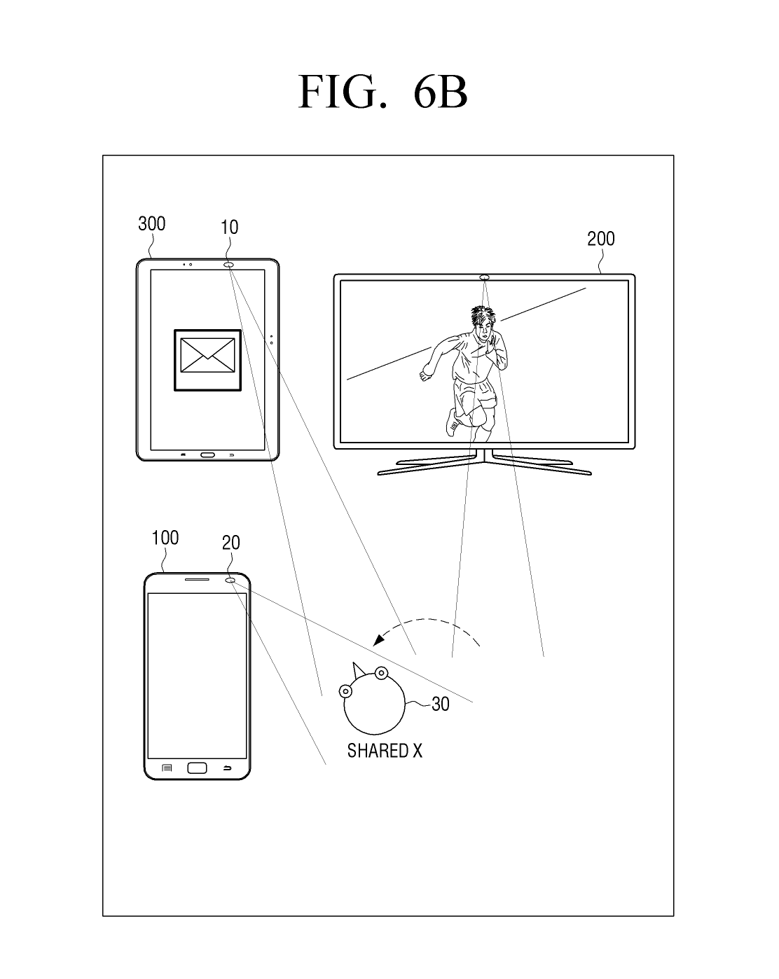

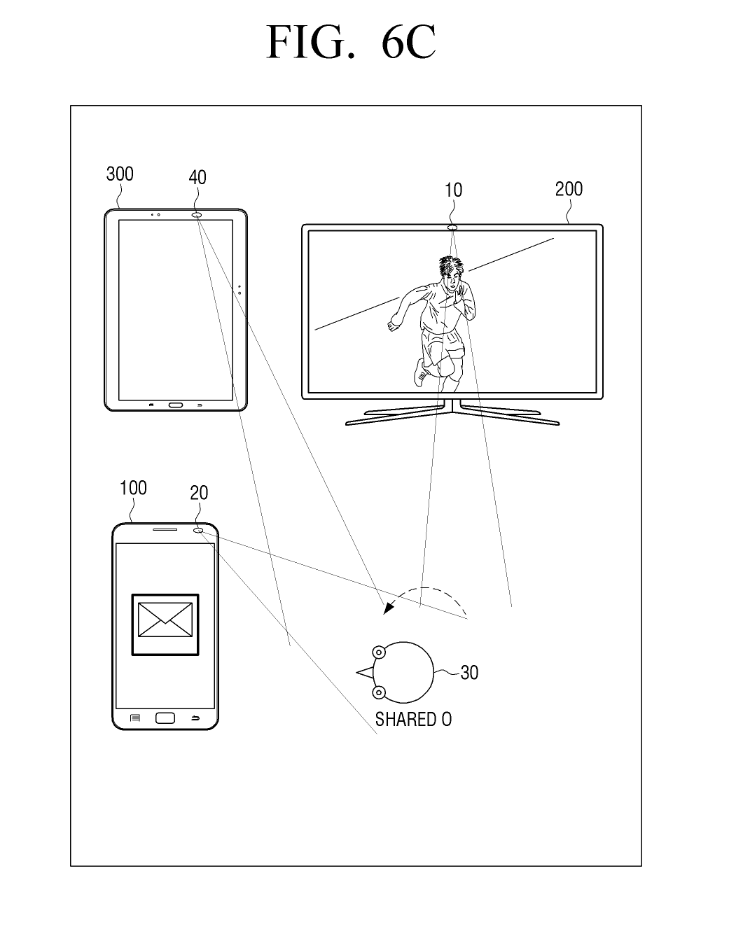

FIGS. 6A to 6C illustrate a content mirroring method according to an exemplary embodiment.

In FIGS. 6A to 6C, it is assumed that the user terminal apparatus 100 and the first display apparatus 200 (and/or a second display apparatus 300) transmits or receives information regarding a user (30)'s gaze by communication. For example, the user terminal apparatus 100 and the first display apparatus 200 run an application that provides the content mirroring function based on gaze tracking.

With reference to FIG. 6A, when it is determined that the user 30 gazes at the first display apparatus 200, information regarding an event that has occurred in the user terminal apparatus 200 may be transmitted to the first display apparatus 200 and be provided by the first display apparatus 200.

For example, information regarding the user (30)'s gaze, which has been tracked using a camera 20 of the user terminal apparatus 100, may be transmitted to the first display apparatus 200. The first display apparatus 200 may determine the position of the user (30)'s gaze based on the received information, as well as information regarding the user (30)'s gaze tracked using a camera 10 of the first display apparatus 200. When it is determined that the user 30 gazes at the first display apparatus 200, the first display apparatus 200 may request, from the user terminal apparatus 100, information received by the user terminal apparatus 100, and may display information notifying the user of a text message that the user terminal apparatus 100 receives. Subsequently, content of the text message may be mirrored and provided by the first display apparatus 200 according to a user command.

Accordingly, the user 30 may share content received by the user terminal apparatus 100, a private device, with other users through the first display apparatus 200, a public device.

Subsequently, when it is determined that the user 30 gazes at the second display apparatus 300 as shown in FIG. 6B, information regarding an event that has occurred in the user terminal apparatus 100 is not transmitted to the first display apparatus 200 but is transmitted to the second display apparatus 300 so that the second display apparatus 300 may provide the user 30 with the information. That is, the user 30 may check the information using a device selected by the user 30 between the plurality of external devices 200 and 300.

Subsequently, when it is determined that the user 30 gazes at the user terminal apparatus 100 instead of the first and second display apparatuses 200 and 300, as shown in FIG. 6C, information regarding an event that has occurred in the user terminal apparatus 100 is not mirrored by the first or second display apparatus 200 or 300, but is displayed only on the user terminal apparatus 100.

In FIGS. 6A to 6C, a corresponding device provides information by tracking the user (30)'s gaze in chronological order, but this is merely an example. The exemplary embodiments shown in FIGS. 6A to 6C may be separately performed.

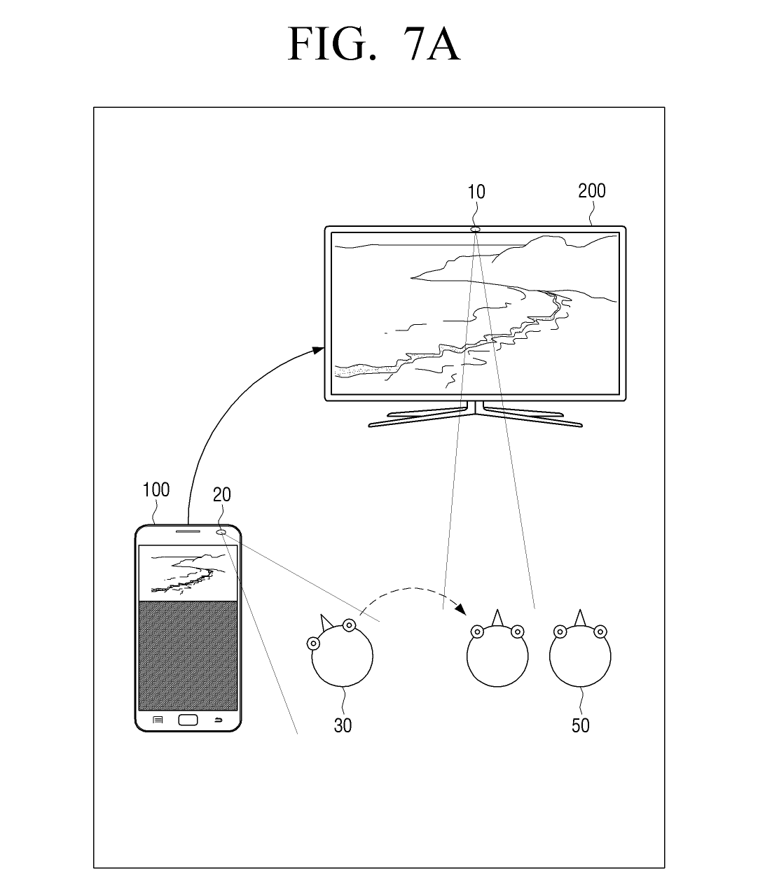

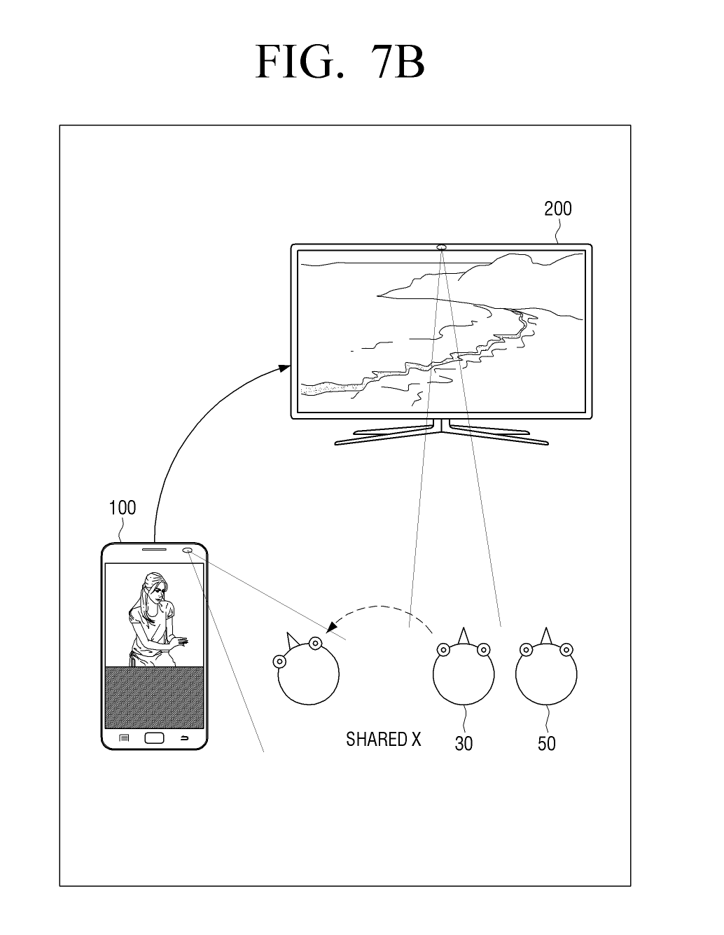

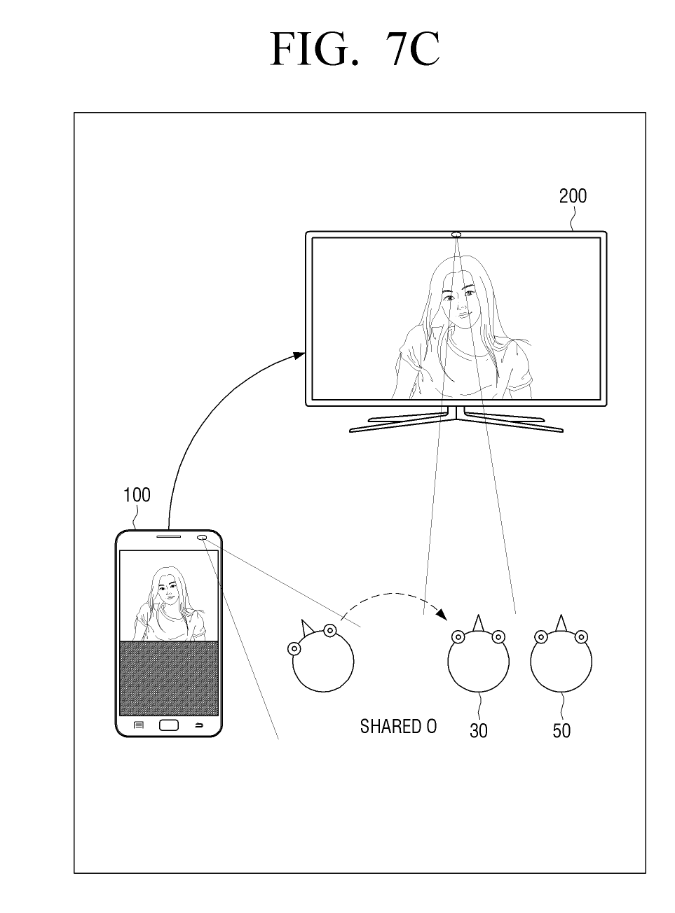

FIGS. 7A to 7C illustrate a content mirroring method according to another exemplary embodiment.

When it is determined that the user 30 gazes at the user terminal apparatus 100 at first and then turns his gaze to the display apparatus 200 as shown in FIG. 7A, content provided by the user terminal apparatus 100 is transmitted to the display apparatus 200 so that the display apparatus 200 may provide the user with the content.

For example, when the user 30 gazing at an image through the user terminal apparatus 100 turns his gaze to the display apparatus 200, the user 30 may share the image with another user 50 through the display apparatus 200.

Subsequently, when it is determined that the user 30 gazing at the display apparatus 200 turns his gaze to the user terminal apparatus 100 as shown in FIG. 7B, the content mirroring function of the display apparatus 200 may be halted.

For example, when the user 30, who is sharing an image with another user 50 through the display apparatus 200, turns his gaze to the user terminal apparatus 100, the content mirroring function of the display apparatus 200 may be halted and the image may be provided by the user terminal apparatus 100 only.

Subsequently, when it is determined that the user 30 turns his gaze back to the display apparatus 200 as shown in FIG. 7C, the content mirroring function of the display apparatus 200 may be performed.

Therefore, the user 30 may share with another user 50 only content that the user wants among the contents of the user terminal apparatus 100 through the display apparatus 200.

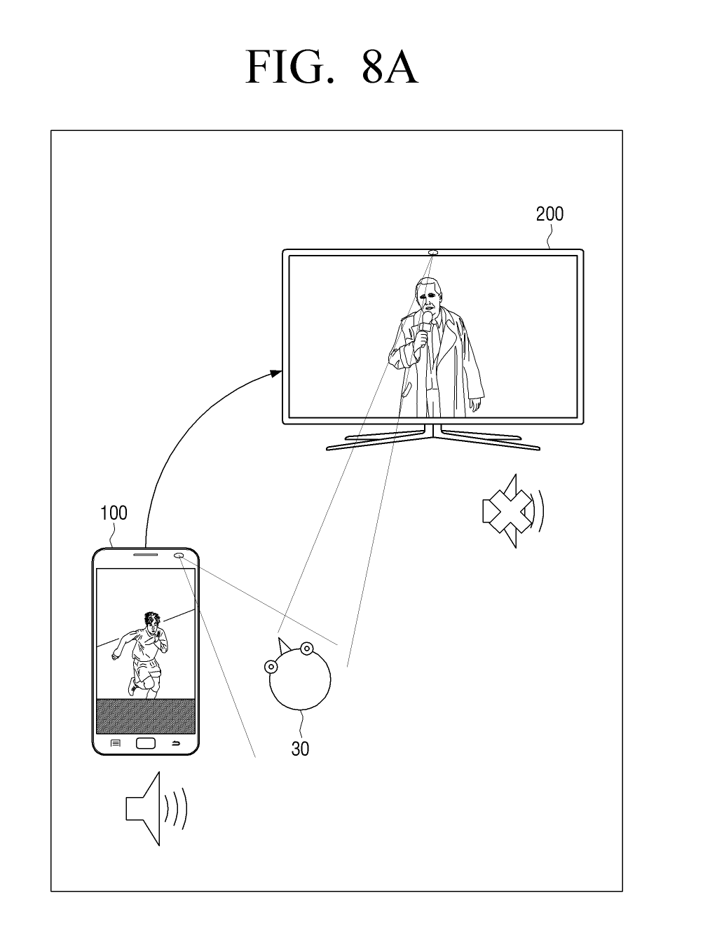

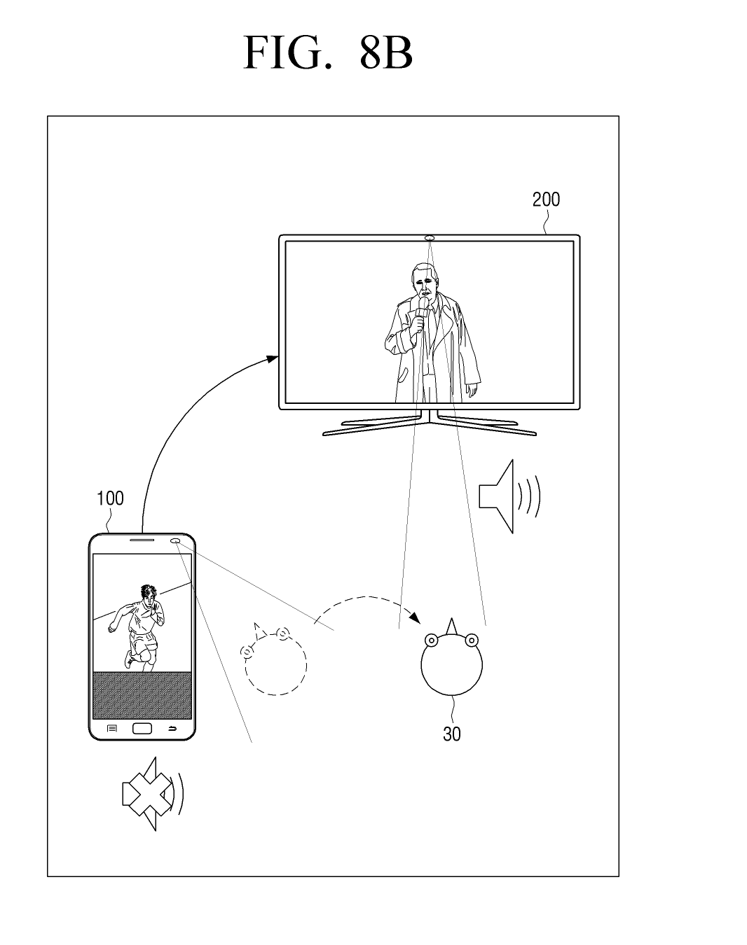

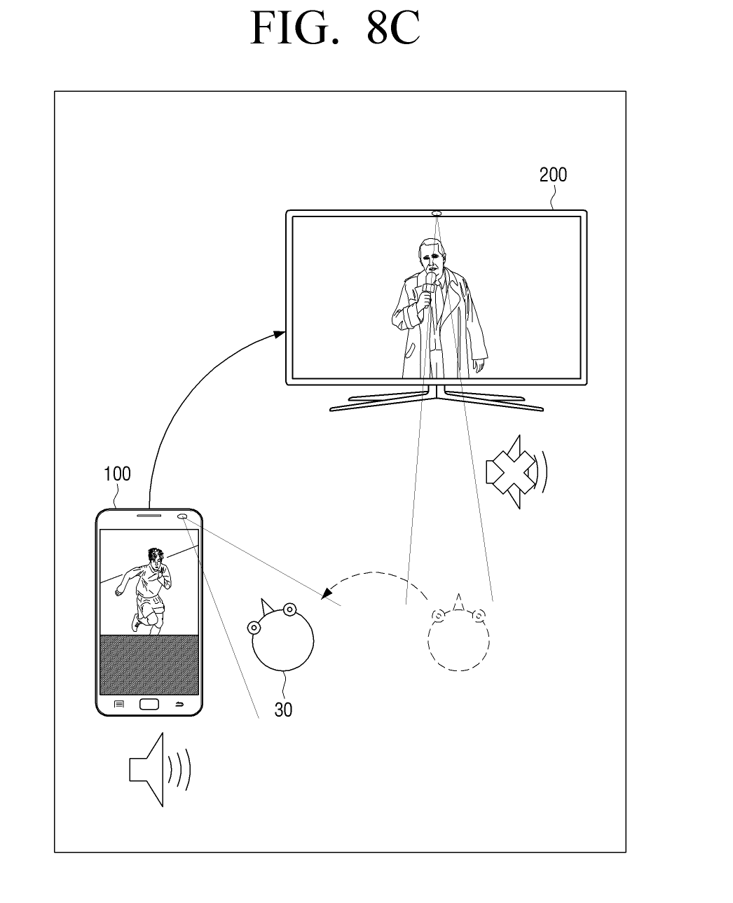

FIGS. 8A to 8C illustrate an output state control method according to an exemplary embodiment.

When it is determined that the user 30 gazes at the user terminal apparatus 100 as shown in FIG. 8A, an audio output state of the display apparatus 200 may be controlled.

For example, when it is determined that the user 30 gazes at the user terminal apparatus 100 as shown in FIG. 8A, an audio output state of the display apparatus 200 may become muted so that content viewing of the user 30 through the user terminal apparatus 100 may not be disturbed.

Subsequently, when it is determined that the user 30 turns his gaze to the display apparatus 200 as shown in FIG. 8B, an audio output state of the user terminal apparatus 100 may become muted so that content viewing of the user 30 through the display apparatus 200 may not be disturbed.

Subsequently, when it is determined that the user 30 turns his gaze back to the user terminal apparatus 100 as shown in FIG. 8C, the audio output state of the display apparatus 200 may become muted.

Therefore, the user may be provided with optimal viewing environment of a device that the user wants by simply moving his gaze.

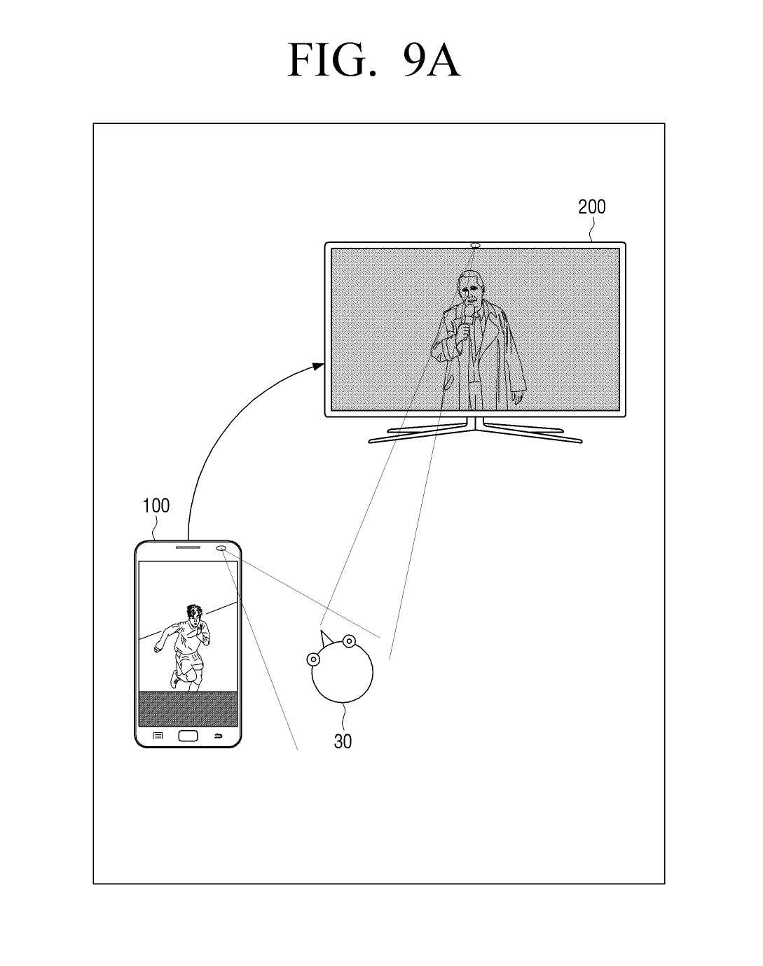

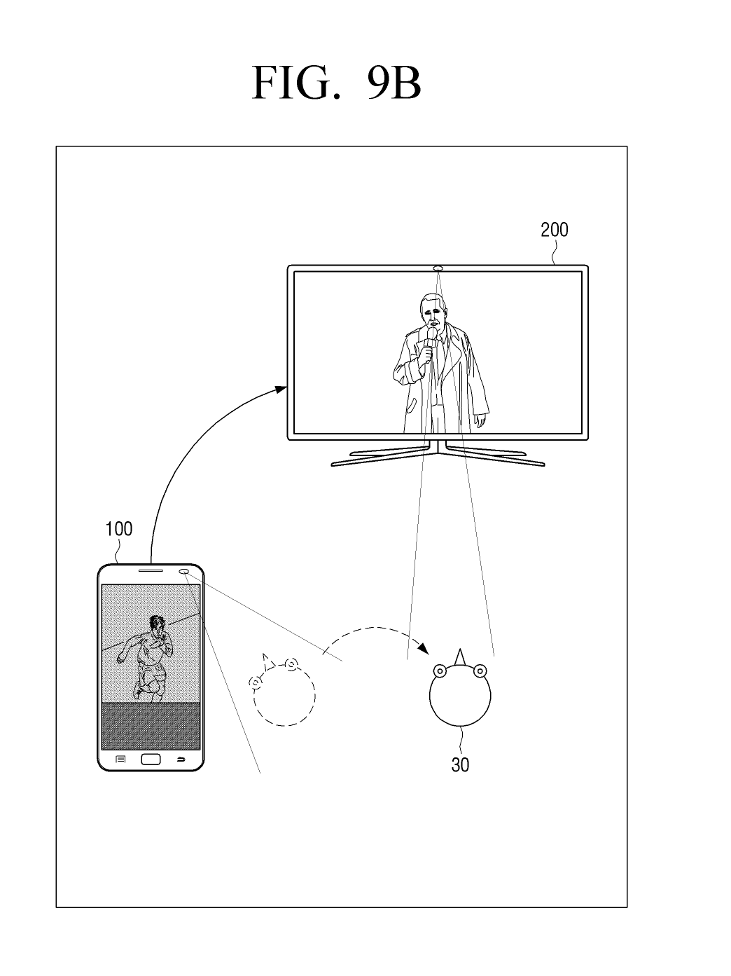

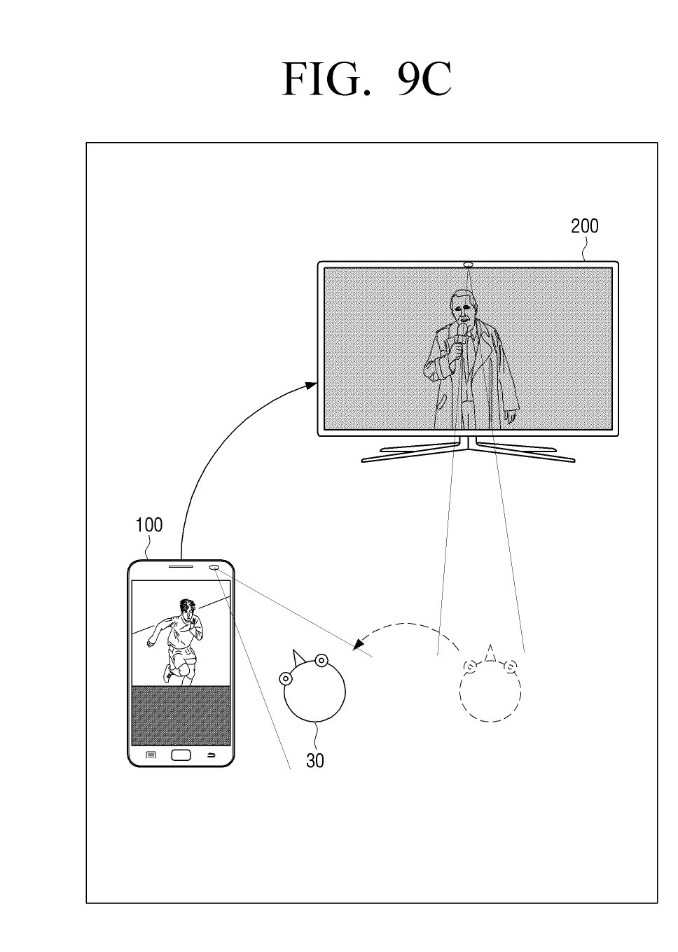

FIGS. 9A to 9C illustrate an output state control method according to another exemplary embodiment.

When it is determined that the user 30 gazes at the user terminal apparatus 100 as shown in FIG. 9A, a screen output state of the display apparatus 200 may be controlled.

For example, when it is determined that the user 30 gazes at the user terminal apparatus 100 as shown in FIG. 9A, a screen output state of the display apparatus 200 may be controlled to have low brightness so that unnecessary power consumption of the display apparatus 200 may be prevented.

Subsequently, when it is determined that the user 30 turns his gaze to the display apparatus 200 as shown in FIG. 9B, a screen output state of the user terminal apparatus 100 may be controlled to have low brightness so that unnecessary power consumption of the user terminal apparatus 100 may be prevented. In this case, the screen output state of the display apparatus 200 may return to the original state.

Subsequently, when it is determined that the user 30 turns his gaze back to the user terminal apparatus 100 as shown in FIG. 9C, the screen output state of the display apparatus 200 may be controlled to have low brightness, and the screen output state of the user terminal apparatus 100 may return to the original state.

Therefore, unnecessary power consumption may be prevented by simply moving the user's gaze.

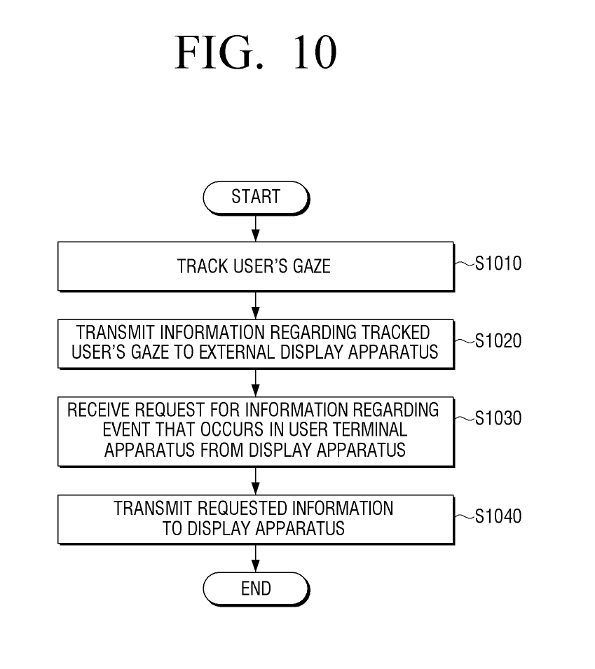

FIG. 10 is a flow chart of a control method of the user terminal apparatus 100 according to an exemplary embodiment.

According to the control method of the user terminal apparatus 100 as shown in FIG. 10, the user terminal apparatus 100 tracks a user's gaze first (S1010).

Subsequently, the user terminal apparatus 100 transmits information regarding the tracked user's gaze to the external display apparatus 200 (S1020).

When a request for information regarding an event that has occurred in the user terminal apparatus 100 is received from the display apparatus 200 (S1030), the user terminal apparatus 100 transmits the requested information to the external display apparatus 200 (S1040).

In operation S1040, when a request for content displayed on the user terminal apparatus 100 is received from the external display apparatus 200, the user terminal apparatus 100 may transmit the requested content to the external display apparatus 200.

In addition, in operation S1040, when a request for information that the user terminal apparatus 100 receives is received from the external display apparatus 200, the user terminal apparatus 100 may transmit the requested information to the external display apparatus 200.

In addition, when a control request for an output state of the user terminal apparatus 100 is received from the external display apparatus 200, the user terminal apparatus 100 may control the output state of the user terminal apparatus 100 based on the received control request.

The output state of the user terminal apparatus 100 may include at least one of a screen output state and an audio output state of the user terminal apparatus 100.

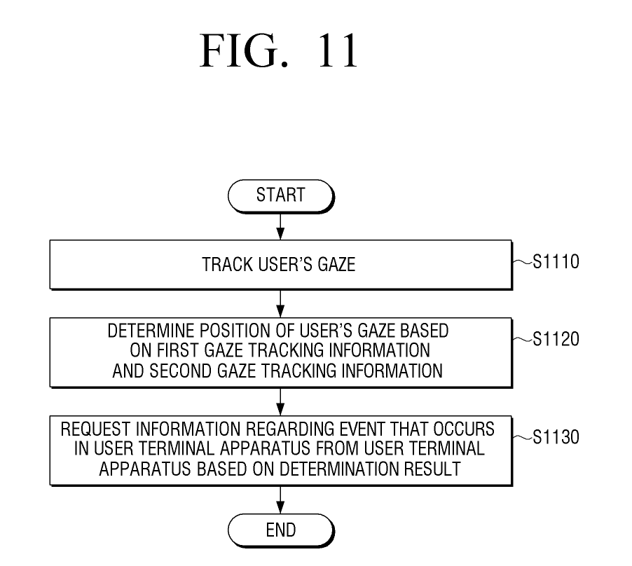

FIG. 11 is a flow chart of a control method of the display apparatus 200 according to an exemplary embodiment.

According to the control method of the display apparatus 200 as shown in FIG. 11, the display apparatus 200 acquires first gaze tracking information by tracking a user's gaze (S1110).

Subsequently, the display apparatus 200 determines a position of the user's gaze based on the first gaze tracking information and second gaze tracking information received from the user terminal apparatus 100 (S1120).

Subsequently, the display apparatus 200 requests information regarding an event that has occurred in the user terminal apparatus 100 from the user terminal apparatus 100 based on the determination result of operation S1120 (S1130).

The method may further include displaying content received from the user terminal apparatus 100 in response to the request transmitted to the user terminal apparatus 100.

In addition, the method may further include controlling an output state of the display apparatus 200 based on the determination result. The output state of the display apparatus 200 may include at least one of a screen output state and an audio output state of the display apparatus 200.

According to one or more exemplary embodiments, a content mirroring function that coincides with the user's intention may be provided. In addition, when content is viewed using the content mirroring function, an optimal viewing environment may be provided.

A control method of the display apparatus according to one or more exemplary embodiments described herein may be implemented with a program and be provided to user terminal apparatuses and display apparatuses.

For example, a non-transitory computer readable medium that stores a program to perform operation of acquiring first gaze tracking information by tracking a user's gaze, determining a position of the user's gaze based on the first gaze tracking information and second gaze tracking information received from a user terminal apparatus, and requesting information regarding an event that has occurred in the user terminal apparatus from the user terminal apparatus based on determination result may be provided to a display apparatus.

The non-transitory computer readable medium may be a medium which does not store data temporarily such as a register, cash, and memory but stores data semi-permanently and is readable by devices. More specifically, the aforementioned application or program may be stored in non-transitory computer readable media such as compact disks (CDs), digital video disks (DVDs), hard disks, Blu-ray disks, universal serial buses (USBs), memory cards, and read-only memory (ROM).

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A user terminal apparatus comprising:
a communicator configured to communicate with an external display apparatus;
a gaze tracker configured to track a user's gaze; and
a controller configured to control the communicator to transmit information regarding the user's gaze acquired by the gaze tracker to the external display apparatus, and, when a request for information regarding an event that has occurred in the user terminal apparatus is received from the external display apparatus, to control the communicator to transmit the requested information to the external display apparatus.

2. The user terminal apparatus as claimed in claim 1, wherein when a request for content that the user terminal apparatus is displaying is received from the external display apparatus, the controller controls the communicator to transmit the requested content to the external display apparatus.

3. The user terminal apparatus as claimed in claim 1, wherein when the user terminal apparatus receives, from the external display apparatus, a request for information that the user terminal apparatus has received, the controller controls the communicator to transmit the received information to the external display apparatus.

4. The user terminal apparatus as claimed in claim 1, wherein when a control request for an output state of the user terminal apparatus is received from the external display apparatus, the controller controls the output state of the user terminal apparatus based on the received control request.

5. The user terminal apparatus as claimed in claim 4, wherein the output state of the user terminal apparatus includes at least one of a screen output state of the user terminal apparatus and an audio output state of the user terminal apparatus.

6. A display apparatus comprising:
a communicator configured to communicate with an external user terminal apparatus;
a gaze tracker configured to track a user's gaze; and
a controller configured to determine a position of the user's gaze based on first gaze tracking information acquired by the gaze tracker and second gaze tracking information received from the user terminal apparatus, and to request information regarding an event that has occurred in the user terminal apparatus from the user terminal apparatus based on a determination result.

7. The display apparatus as claimed in claim 6, further comprising:
a display,
wherein the controller controls the display to display content received from the user terminal apparatus.

8. The display apparatus as claimed in claim 6, wherein the controller controls an output state of the display apparatus based on the determination result.

9. The display apparatus as claimed in claim 8, wherein the output state of the display apparatus includes at least one of a screen output state of the display apparatus and an audio output state of the display apparatus.

10. A display system comprising a user terminal apparatus and a display apparatus, wherein:
the user terminal apparatus is configured to transmit information regarding a tracked user's gaze to a display apparatus, and, when a request for information regarding an event that has occurred in the user terminal apparatus is received from the display apparatus, the user terminal apparatus is configured to transmit the requested information to the display apparatus, and
the display apparatus is configured to determine a position of the user's gaze based on gaze tracking information received from the user terminal apparatus and gaze tracking information acquired by the display apparatus, and is configured to request information regarding an event that has occurred in the user terminal apparatus from the user terminal apparatus based on a determination result.

11. A control method of a user terminal apparatus, the method comprising:
tracking a user's gaze;
transmitting information regarding the tracked user's gaze to an external display apparatus; and
when a request for information regarding an event that has occurred in the user terminal apparatus is received from the display apparatus, transmitting the requested information to the external display apparatus.

12. The method as claimed in claim 11, further comprising, when a request for content displayed on the user terminal apparatus is received from the external display apparatus, transmitting the requested content to the external display apparatus.

13. The method as claimed in claim 11, further comprising, when a request for information that the user terminal apparatus has received is received from the external display apparatus, transmitting the requested information to the external display apparatus.

14. The method as claimed in claim 11, further comprising:
when a control request for an output state of the user terminal apparatus is received from the external display apparatus, controlling the output state of the user terminal apparatus based on the received control request.

15. The method as claimed in claim 14, wherein the output state of the user terminal apparatus includes at least one of a screen output state of the user terminal apparatus and an audio output state of the user terminal apparatus.

16. A control method of a display apparatus, the method comprising:
tracking a user's gaze, thereby acquiring first gaze tracking information;
determining a position of the user's gaze based on the first gaze tracking information and second gaze tracking information received from a user terminal apparatus; and
based on a determination result requesting, from the user terminal apparatus, information regarding an event that has occurred in the user terminal apparatus.

17. The method as claimed in claim 16, further comprising:
displaying content received from the user terminal apparatus.

18. The method as claimed in claim 16, further comprising:
controlling an output state of the display apparatus based on the determination result.

19. A control method of a display system comprising a user terminal apparatus and a display apparatus, the method comprising:
the user terminal apparatus transmitting information regarding a tracked user's gaze to the display apparatus;
the display apparatus determining a position of the user's gaze based on gaze tracking information received from the user terminal apparatus and gaze tracking information acquired by the display apparatus;
based on a determination result, the display apparatus transmitting a request for information from the user terminal apparatus regarding an event that has occurred in the user terminal apparatus;
in response to receiving the request for information, the user terminal apparatus transmitting the requested information to the display apparatus.

20. A display system comprising:
a user terminal apparatus and a display apparatus, and at least one gaze tracker which tracks a user's gaze;
wherein the display apparatus comprises a controller which determines a position of a user's gaze based on gaze tracking information received from the at least one gaze tracker; and
wherein the controller determines whether to transmit a request for information to the user terminal apparatus based on the determined position of the user's gaze.
